(19) United States
(12) Patent Application Publication
(10) Pub. No.: US 2008/0086695 A1
(43) Pub. Date: Apr. 10, 2008

(54) METHOD TO COLOR TAG E-MAIL CONTENT CONTAINING MULTIPLE REPLIES TO EASE READING

(75) Inventor: Tolga Oral, Winchester, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/539,887

(22) Filed: Oct. 10, 2006

(51) Int. Cl. G06F 3/00

(52) U.S. Cl. 715/752

(57) ABSTRACT

A method for color tagging electronic mail (e-mail) content containing multiple replies, such that the e-mail facilitates easy reading by a recipient of the reply e-mail. The method includes receiving e-mail containing various forms of content on a client node. Afterwards, the method proceeds with dispatching a reply e-mail from the client node. The method concludes with tagging for identification of the user the additional content incorporated into the reply e-mail from the user of the client node. The ID tagging being at least one of, (i) color tagging using a specific color for each user's comments rendered during the communication, (ii) color tagging using a dark to light color transition such that time lines are provided for the reply e-mail, (iii) font tagging via usage of a different font style, and (iv) font tagging via usage of a different font size.

### TRADEMARKS

IBM® is registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to messaging communications, and more particularly, to color tagging reply e-mail responses with a particular color that relates to a particular sender of the response.

2. Description of Background

Most of today's electronic mail (e-mail) clients provide threading for e-mails. These threads allow a user the ability to view e-mails in an organized manner in the user's inbox. However, the user still has to be able to recognize the differences between e-mails by themselves as content in the e-mails are not organized in anyway. Depending on the way that e-mail content has been made, this could be easy to very hard. If e-mail replies were only added to the e-mail by including the history, and did not change anything in the previous e-mail content; it would be pretty easy for the user to follow the comments.

However, if an e-mail has been replied to and changes have been made to the original e-mail's content, it may be extremely difficult for the user to follow along with the communication. It could be nearly impossible for the user when the user has not received the entire thread of the e-mail, and was added to the thread half way in the middle of the communication, and the authors of the e-mail did not follow a good pattern for tagging the responses.

Thus, there is a need to organize e-mail responses in a manageable way for users to easily read the responses.

### SUMMARY OF THE INVENTION

The shortcomings of the prior art are overcome and additional advantages are provided through the provision of a method for color tagging electronic mail (e-mail) content containing multiple replies, such that the e-mail facilitates easy reading by a recipient of the reply e-mail. The method includes receiving e-mail containing various forms of content on a client node. The method proceeds with dispatching a reply e-mail from the client node. The reply e-mail contains additional content from a user of the client node. The method concludes with tagging for identification (ID) of the user the additional content incorporated into the reply e-mail from the user of the client node. The ID tagging being at least one of, (i) color tagging using a specific color for each user's comments rendered during the communication, (ii) color tagging using a dark to light color transition such that time lines are provided for the reply e-mail, (iii) font tagging via usage of a different font style, and (iv) font tagging via usage of a different font size.

Additional features and advantages are realized through the techniques of the present invention. Other embodiments and aspects of the invention are described in detail herein and are considered a part of the claimed invention. For a better understanding of the invention with advantages and features, refer to the description and to the drawing.

### TECHNICAL EFFECTS

As a result of the summarized invention, technically we have achieved a solution for a method for color tagging electronic mail (e-mail) content containing multiple replies, such that the e-mail facilitates easy reading by a recipient of the reply e-mail.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a method for color tagging electronic mail (e-mail) content containing multiple replies, such that the e-mail facilitates easy reading by a recipient of the reply e-mail; and

FIG. 2 illustrates one example of a reply e-mail pertaining to the method disclosed in FIG. 1.

The detailed description explains an exemplary embodiment of the invention, together with advantages and features, by way of example with reference to the drawing.

### DETAILED DESCRIPTION OF THE INVENTION

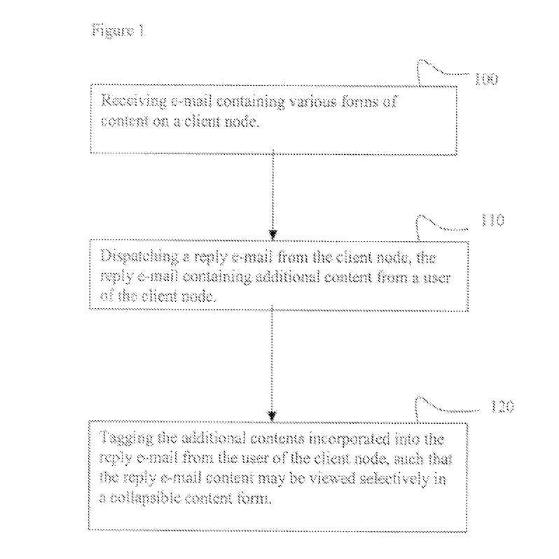

Referring to FIG. 1, a method for color tagging electronic mail (e-mail) content containing multiple replies, such that the e-mail facilitates easy reading by a recipient of the reply e-mail, is shown.

Starting at step 100, an e-mail containing various forms of content is received on a client node. Subsequently, at step 110, a reply e-mail from the client node is dispatched. The reply e-mail contains additional content from a user of the client node. Afterwards, at step 120, the additional contents incorporated into the reply e-mail from the user of the client node are tagged for user response identification (ID). The ID tagging includes at least one of the following forms, (i) color tagging using a specific color for each user's comments rendered during the communication. Secondly, (ii) color tagging using a dark to light color transition such that time lines are provided for the reply e-mail. The reply e-mail may be darker in tone for earlier replies in time and lighter in tone for later replies in time or vice versa. The differences in the tone color occur such that the parties involved in the communication may easily distinguish older sent reply e-mails from recently sent reply e-mails. Thirdly, (iii) font tagging via usage of a different font style, and (iv) font tagging via usage of a different font size.

The additional contents incorporated into the reply e-mail may be tagged by a tab indentation format such that the reply e-mail content is viewable as a discussion thread and may optionally be viewed selectively in a collapsible content form. The discussion thread is displayed in the form of tabbed replies with distinguishing colors. A different color is assigned to each reply, such that a particular color relates to all replies from a particular sender of the reply e-mail.

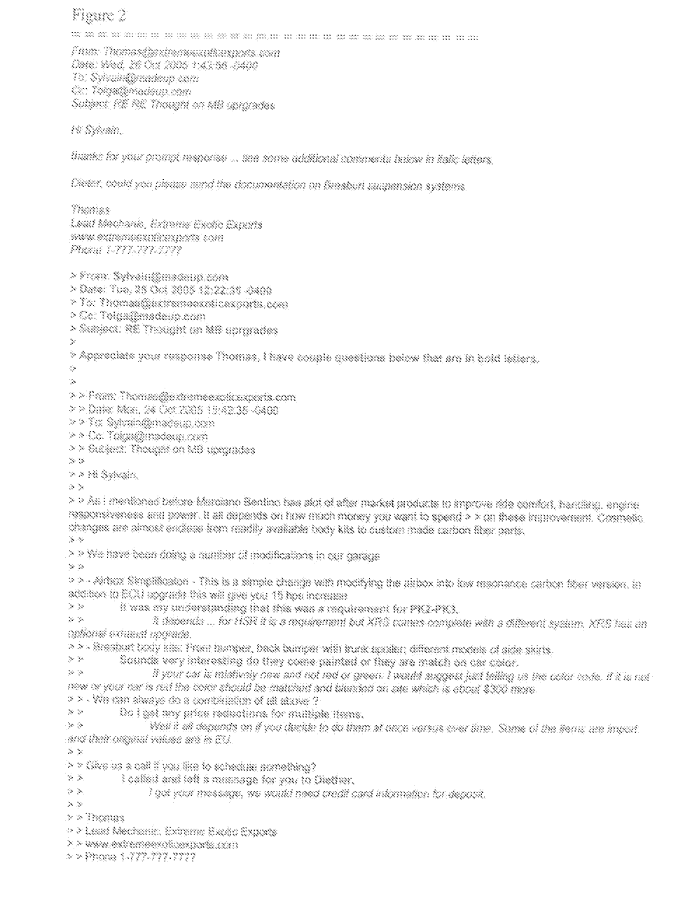

Referring to FIG. 2, a reply e-mail is shown. As shown, the e-mail tagged additional content in the reply by using different fonts, for example, a portion of the communication illustrates normal font and another portion illustrates italicized and bold print font for the additional content in the reply. Furthermore, as shown, the e-mail illustrates the tab indentation format previously disclosed.

In an alternative embodiment for tagging the contents of a reply e-mail, the reply e-mail includes a plurality of horizontal extending equally spaced apart links located at the top and the bottom of the e-mail. The links assigned to each reply e-mail may be different colors such that a particular color relates to all replies from a particular sender of the reply e-mail.

The client node stores the color associated with a particular sender's reply e-mail. If color tagging is utilized for the reply e-mail, the color tagging may be user enabled as well as user disabled.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for color tagging electronic mail (e-mail) content containing multiple replies, such that the e-mail facilitates reading by a recipient of the reply e-mail, comprising:
receiving e-mail containing various forms of content on a client node;
dispatching a reply e-mail from the client node, the reply e-mail containing additional content from a user of the client node; and
tagging for identification (ID) of the user the additional content incorporated into the reply e-mail from the user of the client node, the ID tagging being at least one of, (i) color tagging using a specific color for each user's comments rendered during the communication, (ii) color tagging using a dark to light color transition such that time lines are provided for the reply e-mail, (iii) font tagging via usage of a different font style, and (iv) font tagging via usage of a different font size.

2. The method of claim 1, wherein the additional content incorporated into the reply e-mail is tagged by a tab indentation format such that the reply e-mail content is viewable as a discussion thread and may be viewed selectively in a collapsible content form.

3. The method of claim 2, wherein the discussion thread is displayed in the form of tabbed replies with distinguishing colors, a different color being assigned to each reply such that a particular color relates to all replies from a particular sender of the reply e-mail.

4. The method of claim 3, wherein the reply e-mail is darker in tone for earlier replies in time and lighter in tone for later replies in time to distinguish older sent reply e-mails from recently sent reply e-mails.

5. The method of claim 4, wherein the reply e-mail includes a plurality of horizontal extending equally spaced apart links located at the top and the bottom of the e-mail, the links being a different color such that a particular color relates to all replies from a particular sender of the reply e-mail.

6. The method of claim 6, wherein the tagging of the reply e-mail may be enabled by the user and disabled by the user.
